(19) United States
(12) Patent Application Publication
(10) Pub. No.: US 2006/0260284 A1
(43) Pub. Date: Nov. 23, 2006

(54) Air filtration assembly

(76) Inventor: Eugenio Masciotra, Montreal (CA)

Correspondence Address: INVENTARIUM, SUITE 1607, 4050, ROSEMONT BLVD, MONTREAL, QC, H1X2M4, CA

(21) Appl. No.: 11/131,859

(22) Filed: May 18, 2005

(51) Int. Cl. B01D 46/00

(52) U.S. Cl. 55/493; 55/481; 55/495

(57) ABSTRACT

An air filtration assembly including a filter and an air duct. The air duct defines an inlet, an outlet and passageway extending therebetween. The air duct further defines a filter-receiving portion for receiving the filter between the inlet and the outlet. The filter-receiving portion includes a filter-retaining surface extending substantially radially inwardly into the passageway. The filter-receiving portion includes a filter-securing assembly for securing the filter against the filter-retaining surface. The filter-securing assembly is selectively operable between a non-retaining configuration and a retaining configuration. In the non-retaining configuration, the filter is removable from the filter-receiving portion. In the retaining configuration, the filter is secured against the filter-retaining surface through the filter-securing assembly engaging at least in part the filter so as to bias the filter towards the filter-retaining surface.

### FIELD OF THE INVENTION

The present invention relates to air filtration. More specifically, the present invention is concerned with an air filtration assembly.

### BACKGROUND OF THE INVENTION

In a commonly used type of air filtration assembly, a removable filter is inserted within an air duct. A flange extends substantially radially inwardly within the air duct and the filter abuts the flange. Such equipment is typically used in many types of industries, including in restaurants and in the pharmaceutical industry, among others.

If the filter is a high efficiency filter, there is a need to have a relatively good seal between the filter and the flange. Indeed, having a high efficiency filter while allowing some contaminated air to pass around the filter results in air that is still contaminated, which defeats the objective typically pursued through the use of a high efficiency filter.

In a first prior art method, the filter extends substantially across the whole cross-section of the air duct and is simply pushed by air pressure onto the flange. However, this method is relatively complex to implement properly if air leaks between the filter and the flange are to be minimized. For example, the air pressure needs to be relatively high so that the contact between the air filter and the flange results in the substantially air tight seal. In addition, any imperfections in the filter or the flange will result in leaks through which the contaminated air may flow.

In another prior art method, the filter is screwed to the flange through the use of screws that engage both the filter and the flange. While it is relatively easy to obtain a good seal using this method, there are some drawbacks, especially in the restaurant industry.

Indeed, the screws and the filter are typically located upstream from the flange and are therefore exposed to the contaminated air. If the contaminated air contains grease or oils, for example, the screws and the filter will become soiled during use of the air filtration assembly. When time comes to change the filter, technicians then typically have to manipulate dirty components. Therefore, it is common for people installing such filters to only fasten some of the screws, namely those that will results in relatively low exposure to dirty components upon removal of the filter. The installation of only some of the screws may result in air leaks between the filter and the flange.

Against this background, there exists a need in the industry to provide a novel air filtration assembly.

### OBJECTS OF THE INVENTION

An object of the present invention is therefore to provide an improved air filtration assembly.

### SUMMARY OF THE INVENTION

In a first broad aspect, the invention provides an air filtration assembly. The air filtration assembly includes a filter. An air duct defines an inlet, an outlet and passageway extending therebetween. The air duct further defines a filter-receiving portion for receiving the filter between the inlet and the outlet. The filter-receiving portion includes a filter-retaining surface extending substantially radially inwardly into the passageway. The filter-receiving portion includes a filter-securing assembly for securing the filter against the filter-retaining surface. The filter-securing assembly is selectively operable between a non-retaining configuration and a retaining configuration. In the non-retaining configuration, the filter is removable from the filter-receiving portion. In the retaining configuration, the filter is secured against the filter-retaining surface through the filter-securing assembly engaging at least in part the filter so as to bias the filter towards the filter-retaining surface.

In some embodiments of the invention, the filter-securing assembly includes a filter-securing member having a cam.

Advantageously, the filter-securing assembly is relatively easy to use and is positionable so that exposure of an intended user to dirty parts of the air filtration assembly during installation and removal of the filter is relatively small.

In addition, the filter-securing assembly is relatively easy to use, relatively ergonomic, and does not require specialized equipment to achieve the retaining configuration.

In some embodiments of the invention, the filter-securing assembly is retrofittable to existing air filtration assemblies. In these embodiments, the filter-securing assembly is relatively easy to install.

The filter-retaining assembly is relatively easy to manufacture and, if desired, manufacturable at relatively low costs.

In a second broad aspect, the invention provides a filter-securing assembly retrofittable to an air filtration assembly.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1, in a perspective view, illustrates an air filtration assembly in accordance with an embodiment of the present invention, the air filtration assembly including a filter-securing assembly shown in a non-retaining configuration;

FIG. 2, in a top plan view, illustrates the air filtration assembly of FIG. 1;

FIG. 3, in a perspective view, illustrates the filter-securing assembly of FIG. 1;

FIG. 4, in a top plan view, illustrates a filter-securing member of the retaining assembly of FIG. 1; and

FIG. 5, in a side elevation view, illustrates the operation of the filter-securing assembly of FIG. 1 between a non-retaining configuration and a retaining configuration.

### DETAILED DESCRIPTION

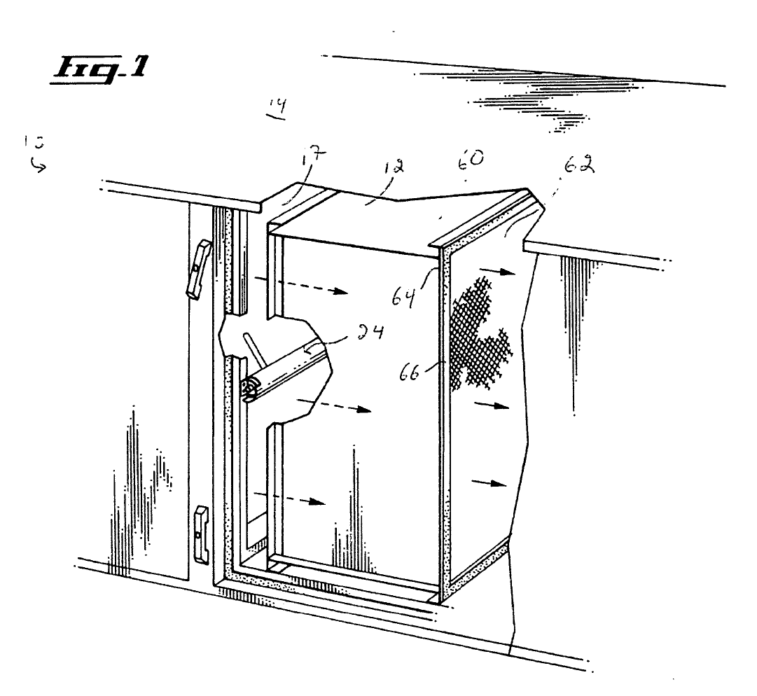

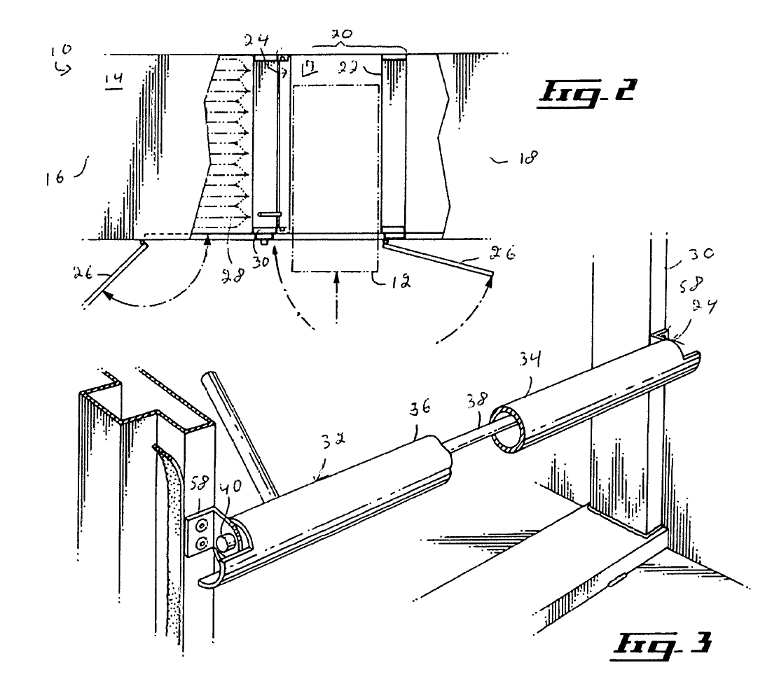

FIGS. 1 and 2 illustrate an air filtration assembly 10 in accordance with an embodiment of the invention. The air filtration assembly 10 includes a filter 12 and an air duct 14. As better illustrated in FIG. 2, the air duct 14 defines an inlet 16 and an outlet 18. A passageway 17 extends between the inlet 16 and the outlet 18.

The air duct 14 defines a filter-receiving portion 20 for receiving the filter 12 between the inlet 16 and the outlet 18. The filter-receiving portion 20 includes a filter-retaining surface 22 extending substantially radially inwardly into the passageway. The filter-receiving portion 20 further includes a filter-securing assembly 24 for securing the filter 12 against the filter-securing surface 22. The filter-securing assembly 24 is selectively operable between a non-retaining configuration and a retaining configuration.

In the non-retaining configuration, the filter 12 is removable from the filter-receiving portion 20. In the retaining configuration, the filter 12 is secured against the filter-retaining surface 22 through the filter-securing assembly 24 engaging at least in part the filter 12 so as to bias the filter 12 towards the filter-retaining surface 22. The retaining and non-retaining configurations are better illustrated in FIG. 5. In this Figure, the filter-securing assembly is shown in the retaining configuration in full lines and in the non-retaining configuration in phantom lines.

As seen in FIG. 1, in some embodiments of the invention, the filter 12 includes a substantially rigid frame 60 within which a filtering material 62 is mounted. An abutment surface 64 of the filter frame 60 is covered with a substantially resilient band of material 66.

The abutment surface 64 faces the filter-retaining surface 22 when the filter 12 is received within the filter-receiving portion 20. Therefore, biasing the abutment surface 64 towards the filter-retaining surface 22 compresses the band of resilient material 66 so as to provide a relatively air tight seal between the filter 12 and the filter-securing surface 22.

Although not present in all embodiments of the invention, in the air filtration assembly shown in FIG. 2 access doors 26 are provided for allowing the insertion and removal of the filter 12 into and out from the air duct 14. In addition to the filter 12, in some embodiments of the invention, other types of filters, such as for example tissue bag filters 28, are provided upstream of the filter 12 or downstream (not shown in the drawings) from the filter 12. Similar air filtration assemblies are well known in the art and the exact configuration of filters and their location within the air filtration assembly will therefore not be further described.

As shown in FIG. 3, the filter-securing assembly 24 includes a filter-securing assembly frame 30 to which a filter-securing member 32 is secured. The filter-securing assembly frame 30 is provided within the air duct 14.

The filter-securing member 32 includes a cam 34. In the non-retaining configuration, the cam 34 is substantially spaced apart from the filter 12. In the retaining configuration, the cam 34 engages at least in part the filter 12 so as to bias the filter 12 towards the filter-retaining surface 22.

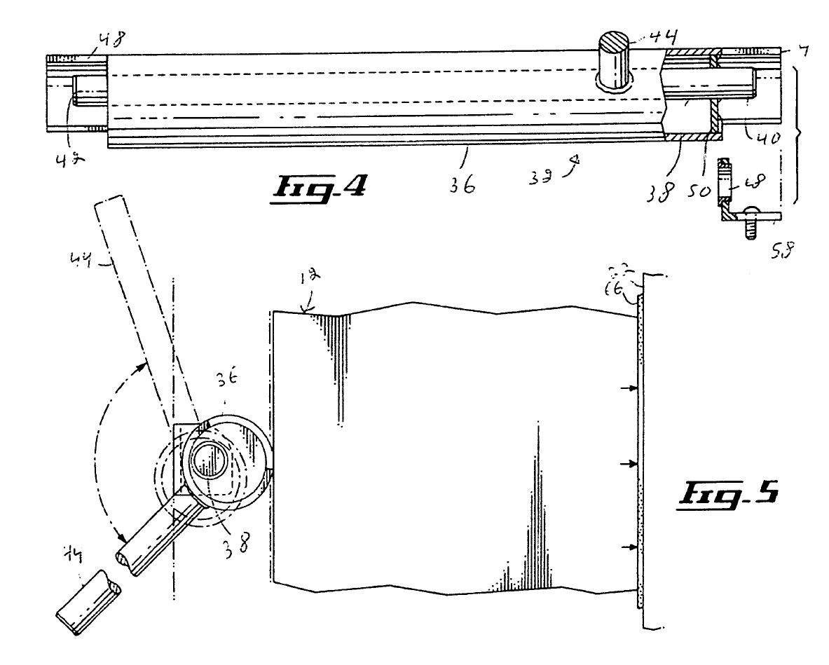

The cam 34 includes a substantially cylindrical cam member 36. As better seen in FIG. 4, a substantially eccentric and substantially elongated cam axle 38 defines first and second substantially opposed cam axle ends 40 and 42. The cam axle 38 mounts the cam 34 within the air duct 14. The cam axle 38 allows the cam 34 to rotate within the air duct 14 so as to alternate between the retaining and non-retaining configurations.

As better illustrated in FIG. 4, in some embodiments of the invention, the filter-securing member 32 includes a handle 44 extending substantially radially outwardly from the cam member 36. For example, the handle 44 is substantially rectilinear and substantially cylindrical. However, in alternative embodiments of the invention, an alternative handle extends from the cam member. In yet other embodiments of the invention, no handle is provided.

In some embodiments of the invention, the cam 32 includes substantially longitudinal cam flanges 46 and 48 extending substantially longitudinally outwardly from the cam member 34 at locations substantially adjacent the cam axle first and second ends 40 and 42.

In addition, in some embodiments of the invention, the substantially cylindrical cam member 34 is a hollow cylindrical shell to which two end plates 50 are secured at the ends thereof. FIG. 4 illustrates only one of the end plates 50. The cam axle 38 is mounted through the end plates 50.

The cam flanges 46 and 48 engage the frame 60 when the filter-securing member is in the retaining configuration. The cam flanges 46 and 48 allow having filters 12 that extend substantially entirely across the air duct 14 while allowing to relatively easily mount the filter-securing member 32 within the air duct 14.

Referring to FIG. 3, in a specific embodiment of the invention, the filter-securing assembly 24 includes first and second mounting brackets 58 located substantially diametrically opposed to each other within the air duct 14. The first and second cam axle ends 40 and 42 are mounted to the first and second mounting brackets 58 and the mounting brackets 58 are secured to the filter-securing assembly frame 30.

In some embodiments of the invention, the brackets 58 are substantially L-shaped and each include a mounting aperture 68 (seen in FIG. 4) for receiving the cam axle 38 therethrough. The mounting brackets 58 are positioned so that the mounting apertures 68 are substantially collinear with the cam axle 38.

In use, the filter 12 is inserted with the air duct 14. Then, an intended user grasps the handle 44 and rotates the cam 32 about the cam axle 38, thereby causing the cam flanges 46 and 48 to engage the filter frame 60. This causes the filter 12 to be biased towards the filter-retaining surface 22, which in turn causes the resilient material 66 to be compressed and produce a substantially airtight seal. Removal of the filter 12 from the air filtration assembly 10 is performed by reversing these steps.

In some embodiments of the invention, the handle 44 is positioned and dimensioned so that when the filter-securing assembly 24 is in the retaining configuration, the filter-securing member 32 is in equilibrium with respect to gravity and therefore shows no tendency to rotate about the cam axle 38. In other words, the center of mass of the filter-securing member 32 in the retaining configuration is substantially vertically aligned with the longitudinal axis of the cam axle 38. Since the filter-securing member 32 is in equilibrium, vibrations present in the air filtration assembly 10 are unlikely to cause the filter-securing member 32 to move towards the non-retaining configuration.

In some embodiments of the invention, the filter-securing assembly 24 is manufactured with the rest of the air filtration assembly 10. In other embodiments of the invention, the filter-securing assembly 24 is retrofittable to an already existing air filtration assembly. In these cases, it is only required that mounting brackets 58 be suitably positioned within an existing air duct 14 and that the filter-securing member 32 be mounted to the brackets 58.

In some embodiments of the invention, the filter-securing assembly 24 is manufactured using steel, such as for example stainless steel. However, it is within the scope of the invention to use any suitable material in manufacturing the filter-securing assembly.

Although the present invention has been described hereinabove by way of preferred embodiments thereof, it can be modified, without departing from the spirit and nature of the subject invention as defined in the appended claims.

1. An air filtration assembly, said air filtration assembly comprising:
a filter;
an air duct defining an inlet and an outlet, said air duct defining a passageway extending between said inlet and said outlet, said air duct defining a filter-receiving portion for receiving said filter between said inlet and said outlet;
said filter-receiving portion including a filter-retaining surface extending substantially radially inwardly into said passageway;
said filter-receiving portion including a filter-securing assembly for securing said filter against said filter-retaining surface, said filter-securing assembly being selectively operable between a non-retaining configuration and a retaining configuration, wherein:
in said non-retaining configuration, said filter is removable from said filter-receiving portion; and
in said retaining configuration, said filter is secured against said filter-retaining surface through said filter-securing assembly engaging at least in part said filter so as to bias said filter towards said filter-retaining surface.

2. An air filtration assembly as defined in claim 1, wherein:
said filter-securing assembly includes a filter-securing member, said filter-securing member including a cam;
in said non-retaining configuration, said cam is substantially spaced apart from said filter; and
in said retaining configuration, said cam engages at least in part said filter so as to bias said filter towards said filter-retaining surface.

3. An air filtration assembly as defined in claim 2, wherein:
said cam includes a substantially cylindrical cam member;
said filter-securing member further includes a substantially eccentric and substantially elongated cam axle defining first and second substantially opposed cam axle ends, said cam axle mounting said cam member within said air duct; and
said cam axle allows said cam member to rotate within said air duct so as to achieve said retaining and said non-retaining configurations.

4. An air filtration assembly as defined in claim 3, wherein said filter-securing member includes a handle extending substantially outwardly from said cam member.

5. An air filtration assembly as defined in claim 4, wherein said handle is positioned and dimensioned so that when said filter-securing assembly is in said retaining configuration, said filter-securing member is in gravitational equilibrium with respect to a rotation of said cam about said cam axle.

6. An air filtration assembly as defined in claim 4, wherein said handle extends substantially radially outwardly from said cam member.

7. An air filtration assembly as defined in claim 3, wherein said filter-securing assembly includes first and second mounting brackets located substantially diametrically opposed to each other within said air duct, said first cam axle end being mounted to said first mounting bracket and said second cam axle end being mounted to said second mounting bracket.

8. An air filtration assembly as defined in claim 3, wherein:
said filter includes a substantially rigid frame; and
said cam includes a substantially longitudinal cam flange extending substantially longitudinally outwardly from said cam member at a location substantially adjacent said cam axle first end, said cam flange engaging said frame when said filter-securing member is in said retaining configuration.

9. A filter-securing assembly retrofittable to an air filtration assembly, the air filtration assembly including a filter and an air duct defining an inlet and an outlet, the air duct defining a passageway extending between the inlet and the outlet, the air duct defining a filter-receiving portion for receiving the filter between the inlet and the outlet, the filter-receiving portion including a filter-retaining surface extending substantially radially inwardly into the passageway, said filter-securing assembly including:
a filter-securing member; and
first and second mounting brackets for mounting said filter-securing member within said air duct;
said filter-securing assembly being selectively operable between a non-retaining configuration and a retaining configuration, wherein:
in said non-retaining configuration, said filter is removable from said filter-receiving portion; and
in said retaining configuration, said filter is secured against said filter-retaining surface through said filter-securing member engaging at least in part said filter so as to bias said filter towards said filter-retaining surface.
